(19) United States
(12) Patent Application Publication
(10) Pub. No.: US 2018/0376470 A1
(43) Pub. Date: Dec. 27, 2018

(54) METHOD AND APPARATUS FOR ACCESS POINT TO STATION CONNECTION

(71) Applicant: THOMSON Licensing, Issy-les-Moulineaux (FR)

(72) Inventor: Casimir Johan CRAWLEY, Carmel, IN (US)

(21) Appl. No.: 15/777,787

(22) PCT Filed: Nov. 24, 2015
(86) PCT No.: PCT/US15/62348

§ 371 Date: May 21, 2018

(51) Int. Cl. H04W 72/04; H04W 72/12; H04W 76/19; H04W 28/02; H04W 60/02; H04W 72/08

(52) U.S. Cl. CPC H04W 72/048; H04W 72/0453; H04W 72/121; H04W 84/12; H04W 28/0236; H04W 60/02; H04W 72/085; H04W 76/19

(57) ABSTRACT

A method performed by an AP to transfer remote stations operating on a WLAN from one channel frequency to another channel frequency includes registering all remote stations using the access point on a first channel frequency (405), detecting channel congestion and deciding to switch channel frequency (410). The AP selects a second channel frequency (415), sends one or more channel change messages to all remote stations to change to the second channel frequency (420) and checks whether all registered remote stations reconnect after switching (425). If any registered remote stations are missing then the AP selects another channel frequency (415, 420). The AP continues such testing and until all registered STAs have reconnected or all channels have been selected. If all channels have been selected and any STA is still missing, then the AP indicates reconnection failure (440).

### FIELD

The present disclosure relates to channel changes in a wireless local area network (WLAN), specifically a reliable channel change for all remote stations (STAs) using a specified access point (AP).

### BACKGROUND

Access points (APs) provide wireless connections to remote stations (STAs) in a wireless local area network (WLAN). If APs detect excessive signal degradation and packet loss then different WLAN channels are selected using automatic channel selection (ACS) algorithms. However, ACS algorithms simply choose an uncongested WLAN channel and thus ignore whether a previously connected STA is supported on the new AP channel frequency. The AP doesn't indicate STA disconnection so a user monitoring the AP may erroneously interpret the result as an AP failure. The Wi-Fi Alliance (WFA) doesn't require that APs and STAs support all 802.11 frequencies.

Methods exist for recovery of lost STA connections using the processing power of the disconnected STA. In these solutions, the STA is required to ascertain that it is still connected to the AP after a channel change by the AP. If no connection exists on the new channel frequency between the AP and the STA, then STA has the responsibility of searching possible AP frequencies to try to find the AP and re-establish a connection via the WLAN.

The above method has drawbacks. One is that the STA is required to have the processing ability to conduct its own recovery. Many heritage STAs do not have this capability. Also, the STA could end up communicating with the AP on a frequency that is used by a different group of STAs. Thus, peer STAs which were previously available to the STA are no longer available. Thus, the reliance on the STA to recover from an AP channel change to a channel unsupported by the STA may not be beneficial for all systems. Another option to reestablish the AP to STA connection on the WLAN is desirable.

### SUMMARY

This summary is provided to introduce a selection of concepts in a simplified form as a prelude to the more detailed description that is presented later. The summary is not intended to identify key or essential features of the invention, nor is it intended to delineate the scope of the claimed subject matter.

In one aspect of the disclosure, a method performed by an access point to transfer registered remote stations operating on a first channel frequency in a wireless local area network to a second channel frequency comprises: generating a channel list for remote station operation in the wireless local area network, the channel list used by the access point; registering remote stations using the access point on a first channel frequency; deciding to switch channel frequency; selecting the second channel frequency; sending one or more channel change messages to the registered remote stations to change to the second channel frequency; determining that all registered remote stations have not connected to the access point using the second channel frequency; determining if all channels in the channel list were selected; selecting a third channel frequency if all channels in the channel list were not selected; sending one or more channel change messages to the registered remote stations to change to a third channel frequency; determining if all registered remote stations have connected with the access point using the third channel frequency; using the third channel frequency for the registered remote stations when all the registered remote stations have connected with the access point using the third channel frequency; producing an indication of a remote station connection failure if one or more of the remote stations cannot connect to the access point on any channel selected by the access point.

In another aspect of the disclosure, the method feature of generating a channel list for remote station operation in the wireless local area network comprises using operational frequency information obtained from remote station operational constraints. The method feature of registering remote stations using the access point on a first channel frequency comprises recording a list of remote stations using a first channel frequency. The method feature of deciding to switch channel frequency comprises detecting packet loss and determining that the packet loss exceeds a threshold. The method feature of selecting the second channel frequency comprises selecting a frequency from the channel list used by the access point.

The method feature of sending one or more channel change messages to remote stations to change to the second channel frequency comprises transmitting the channel switch message to each remote station. The method feature of determining that all registered remote stations have not connected to the access point using the second channel frequency comprises the access point comparing the registered remote stations with the remote stations that have reconnected to the access point on the second channel. The method feature of determining if all channels in the channel list were selected comprises reviewing the channel list held by the access point and determining if all channel frequencies were used. The method feature of selecting a third channel frequency if all channels in the channel list were not selected comprises selecting a next channel on the channel list held by the access point.

In another aspect of the disclosure, an access point apparatus operating on a wireless local area network comprises a wireless local area network interface for communicating with a plurality of remote stations; a processor for controlling switching of an operational frequency of the wireless local area network, the processor generating a channel list, deciding to switch channel frequency, transmitting one or more channel switching messages to the plurality of remote stations, the messages instructing the plurality of remote stations to switch to a second channel frequency, the processor determining that all of the plurality of remote stations have not switched to the second channel frequency, transmitting one or more channel switching messages to the plurality of remote stations, the messages instructing the plurality of remote stations to switch to a third channel frequency, determining if all of the plurality of remote stations have switched to the third channel, and operating the remote stations on the third channel frequency if all of the plurality of remote stations have switched to the third channel frequency; and a status indicator for indicating if all of the remote stations have not switched to the third channel frequency.

In another aspect of the disclosure, the access point status indicator feature is one or more of a LED, a display, or an audio alert. The access point can further comprise a network transmitter and receiver for connecting the access point to a core network. The access point processor can further comprise a list of channel frequencies for remote station use. The access processor can decides to switch channel frequency by determining if the first channel is congested by comparing packet loss to a threshold. The access point processor can register remote stations using the first channel frequency to determine if the remote stations have switched to the second channel frequency or the third channel frequency.

Additional features and advantages of the invention will be made apparent from the following detailed description of illustrative embodiments which proceeds with reference to the accompanying figures. It should be understood that the drawings are for purposes of illustrating the concepts of the disclosure and is not necessarily the only possible configuration for illustrating the disclosure.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention. In the drawings, like numbers represent similar elements.

FIG. 1 illustrates an example environment in which the current configuration may be practiced;

FIG. 2A depicts a prior art STA-supported channel information element of IEEE 802.11h;

FIG. 2B depicts a prior art AP channel switch announcement information element of IEEE 802.11h;

FIG. 2C depicts an IEEE 802.11i protocol handshake sequence diagram:

FIG. 2D depicts an access point and station connection state diagram;

FIG. 3A depicts a first part of an example signal exchange diagram between an access point and several remote stations using a WLAN according to an example method of the current configuration;

FIG. 3B depicts a second part of an example signal exchange diagram between an access point and several remote stations using a WLAN according to an example method of the current configuration;

FIG. 4 depicts an example method according to aspects of the current configuration;

FIG. 5 illustrates an example access point according to aspects of the current configuration.

### DETAILED DISCUSSION OF THE EMBODIMENTS

In the following description of various illustrative embodiments, reference is made to the accompanying drawings, which form a part thereof, and in which is shown, by way of illustration, how various embodiments in the invention may be practiced. It is to be understood that other embodiments may be utilized and structural and functional modification may be made without departing from the scope of the present disclosure.

Access points (APs) provide wireless connections to remote stations (STAs). Many residential and commercial wireless local area networks (WLANs) contain enough competing APs that signal degradation and network congestion can produce significant packet loss. APs detect such conditions and subsequently switch WLAN channels using automatic channel selection (ACS) algorithms. However, such APs may select channel frequencies unsupported by previously connected STAs. These algorithms are insufficient in predicting supported STA channel frequencies. APs using the disclosure herein can iterate through all WLAN channels thus allowing previously connected STAs to reconnect or indicate reconnection failure.

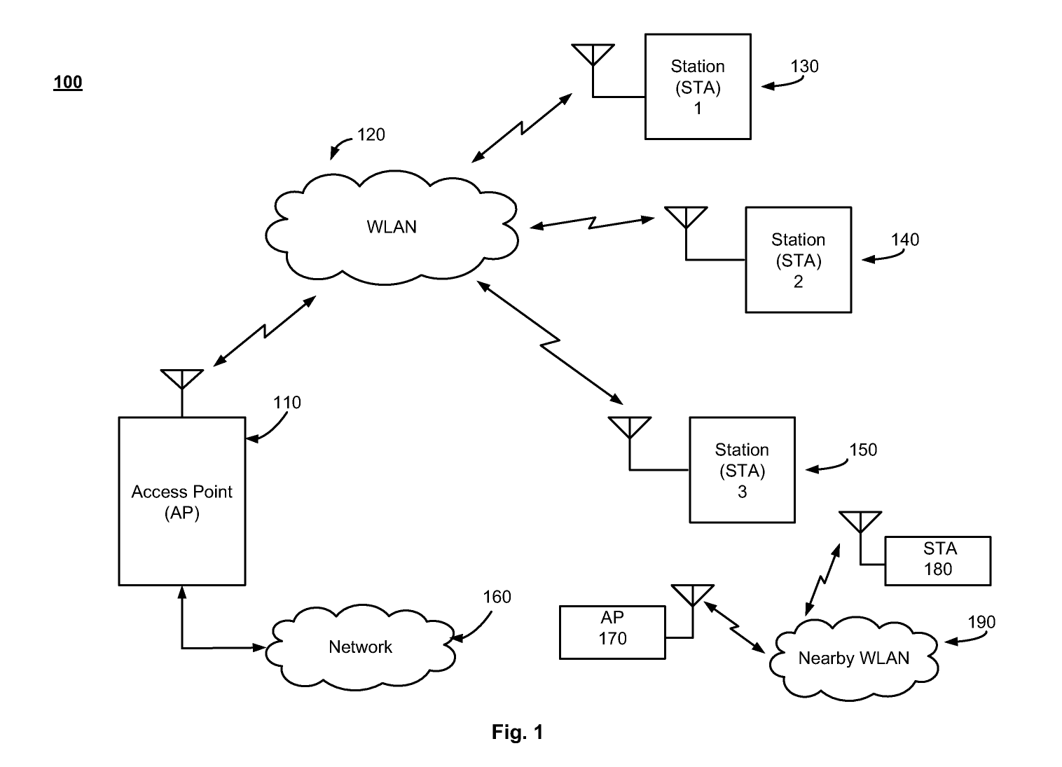

FIG. 1 illustrates a system 100 which serves as an example environment for the present disclosure. An access point (AP) 110 has the capability to control a WLAN 120. The AP can be a router, a gateway, or combination router gateway that can manage the WLAN 120 and provide access to services such as network 160. Network 160 can represent available AP resources such as internet access, storage access, LAN access, and the like. Remote stations STA 1 (130), STA 2 (140), and STA 3 (150) are example remote terminals or stations (STA) that can wirelessly connect to the AP 110 via WLAN 120 to gain access to AP system resources such as network 160. Competing WLANs can cause congestion of available frequencies in the immediate area. WLAN 190 is nearby WLAN 120 and is operated via nearby AP 170 and STA 180. Nearby WLAN 190 is separate from WLAN 120 and can cause RF interference, packet loss, frequency congestion, traffic congestion, and the like.

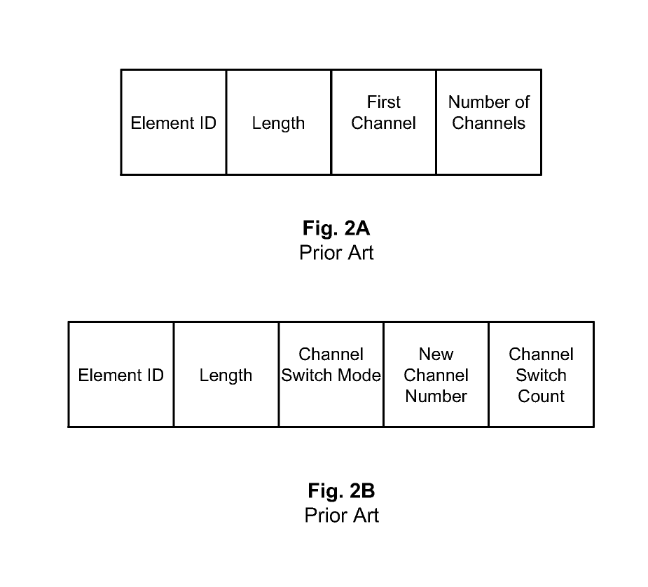

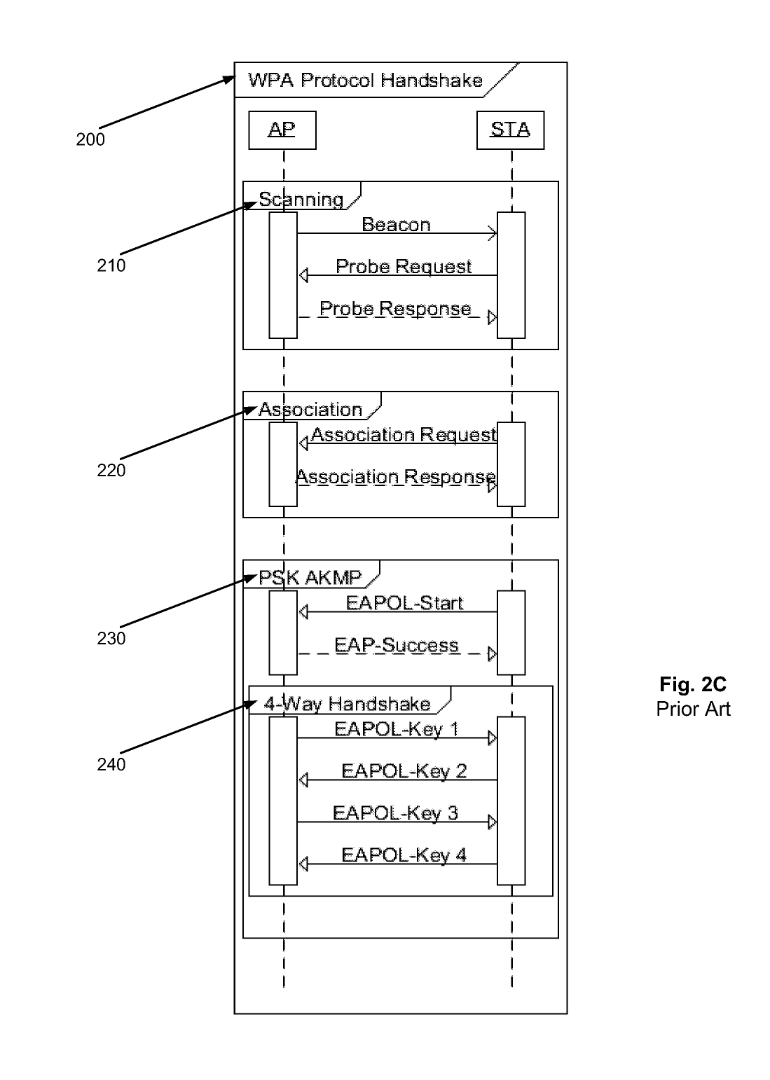

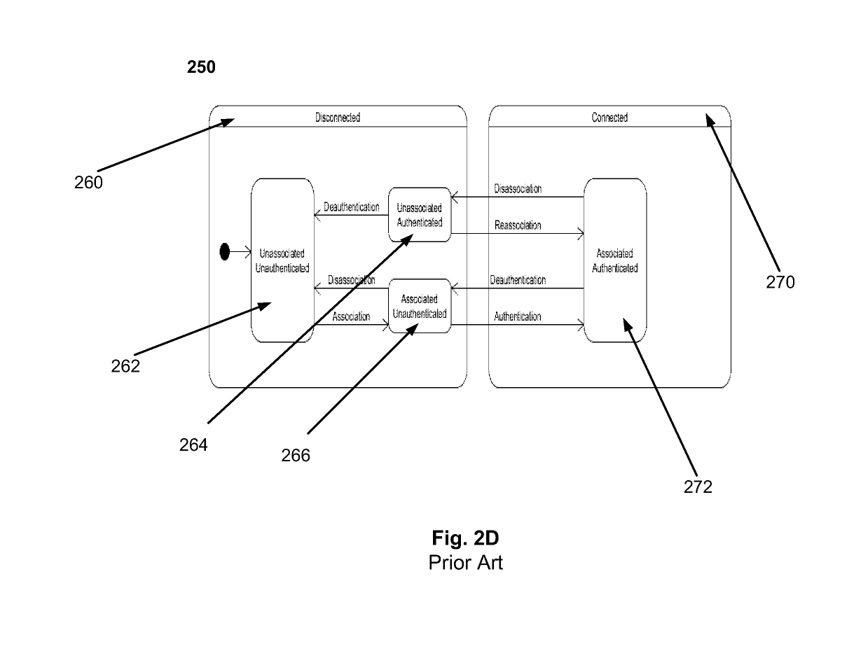

IEEE 802.11h specifies frames containing information elements used in managing WLANs. The 802.11h amendment further specifies information elements for channel management. STAs announce their supported channels by transmitting to APs using the message format shown in FIG. 2A. Using this message, the AP can get information on which channels any individual STA can operate. A channel change is implemented via an IEEE 802.11h channel switch announcement message as shown in FIG. 2B. Using this message, the AP can announce to the STAs the intention to switch to a new channel to avoid the congestion of the present channel.

As is well known to those of skill in the prior art, APs detecting excessive network congestion and packet loss select between WLAN channels using ACS algorithms. Although an AP may record all currently supported channels announced by STAs using the message of FIG. 2A, channel support also does not guarantee network reliability. Another selected channel may introduce new network errors that prevent reconnecting by all STAs.

However, ACS simply chooses an uncongested WLAN channel thus ignoring whether previously connected STAs support the new AP channel frequency. The AP doesn't indicate STA disconnection so a user may erroneously interpret the result as an AP failure. The Wi-Fi Alliance (WFA) doesn't require that APs and STAs support all 802.11 frequencies.

The following disclosure addresses how the AP can accommodate a channel switch for all STAs that it supports. The channel switch is made to avoid further current channel congestion by moving to a quieter channel. In one aspect of the current disclosure, it is the AP, not the STA that ensures that all STAs respond to the channel switch message and are present on the new operating channel.

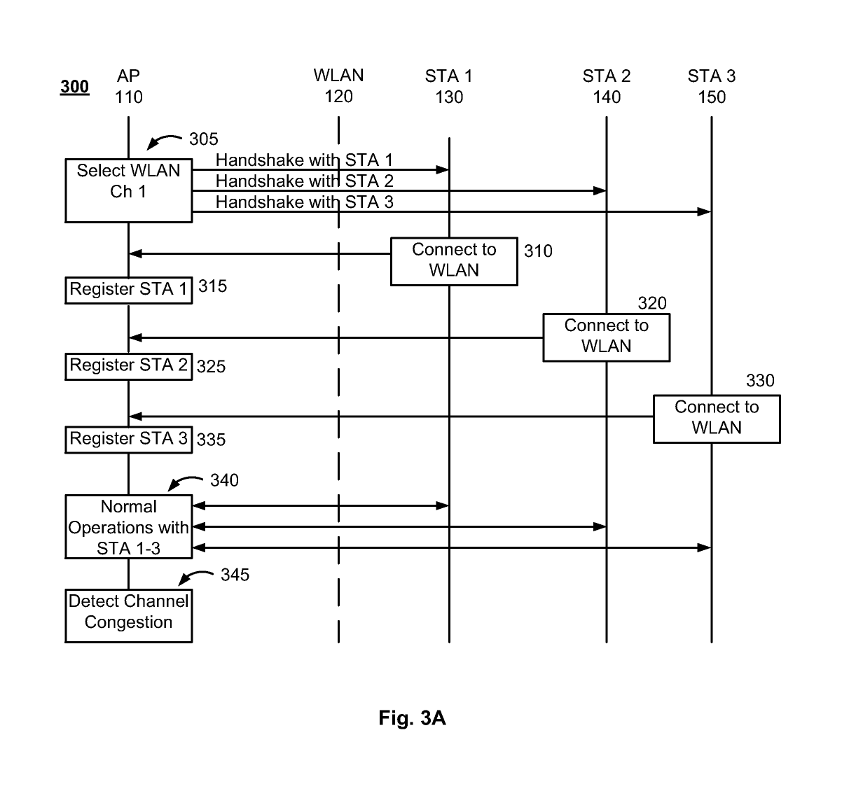

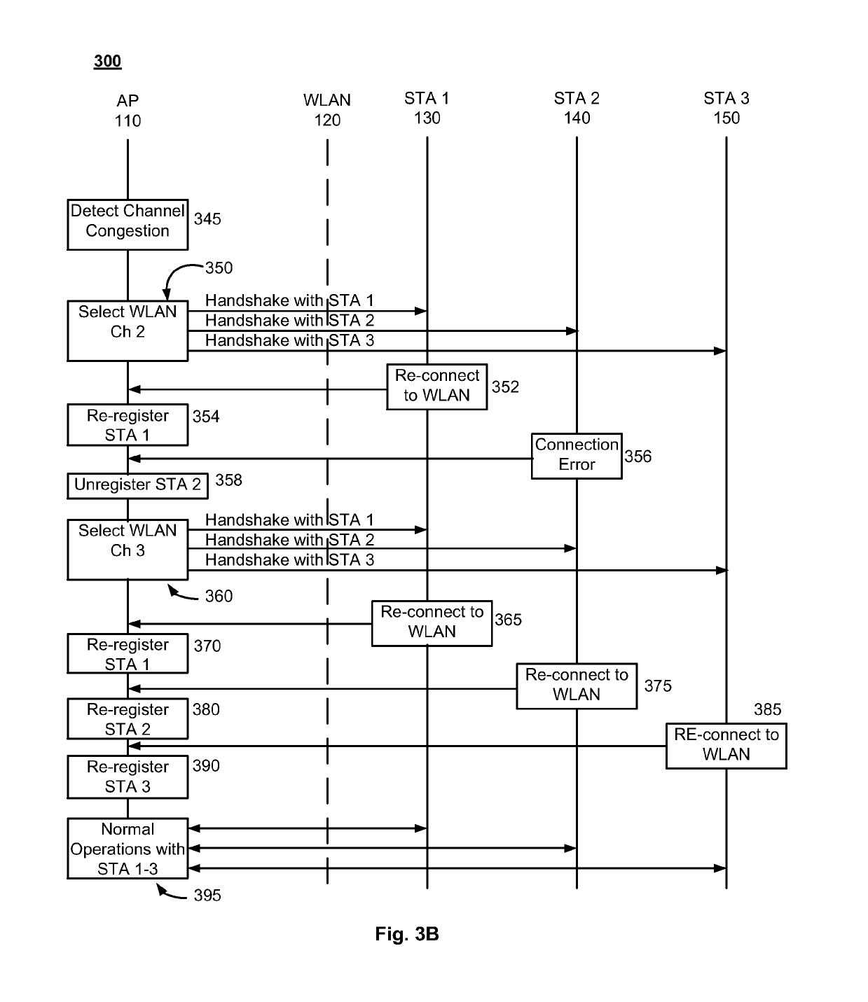

FIG. 2C describes an IEEE 802.11i protocol handshake sequence diagram as known which shows the Wi-Fi Protected Access protocol's event sequence 200 between an AP and STA used in typical small-office home-office (SOHO) environments. A STA discovers an AP's broadcast SSID in the Scanning interaction frame 210. The STA joins with the AP in the subsequent Association interaction frame 220. The AP then authenticates the STA during the Pre-Shared Key Authentication and Key Management Protocol (PSK AKMP) interaction frame 230. The STA can then dynamically obtain network settings thus allowing an internet connection after using 4-way handshake 240. Overall, this WPA protocol handshake 200 is used to describe a connection method for FIGS. 3A and 3B.

FIG. 2D depicts a STA connection state chart shows the relationship between association, authentication, and connection. A disconnected STA 260 can be unassociated and unauthenticated 262, associated and unauthenticated 266, or unassociated and authenticated 264. A connected STA 270 must be associated and authenticated 272 with an AP. Thus, in the following transaction diagrams, a connected STA as shown in diagram state 270 is one that has both association and authentication 272. Whereas, a disconnected STA as shown in diagram state 260 can have any of the three disconnection states.

FIG. 3A is an example transaction or event diagram 300 showing the example flow of operations of the AP 110 and STA 130, 140, and 150 of example configuration FIG. 1 while operating using the features of the current disclosure. Initially, the WLAN 120 is used by the AP as a medium for communicating with STAs 130, 140, and 150. Although three STAs are used in the example, those of skill will realize that more or fewer STAs can be supported by AP 110 using WLAN 120. At event 305, the AP 110 selects a WLAN channel (such as CH 1) and conducts the handshake protocol 200 with the three STAs. At event 310, STA 1 (130) connects to the WLAN as a result of the handshake with the AP. The connection to the WLAN at event 310 represents an association of STA 1 (130) with the AP 110 and the reception of IP network settings. As a result of STA 1 (130) connecting to the WLAN, the AP at event 315 registers STA 1 (130).

Similarly, at event 320, STA 2 (140) connects to the WLAN, obtains the STA 2 network settings and the AP 110 registers STA 2 at event 325. At event 330, STA 3 (150) connects to the WLAN, obtains network settings, and the AP 110 registers STA 3 at event 335. The AP handshakes with the STAs and the connection of the STAs to the WLAN can be made in any order as is understood by those of skill in the art. Registration occurring at the AP 110 records STA 1, STA 2 and STA 3 as remote stations associated and authenticated with AP 110. The registration of STA 1, STA 2, and STA 3 helps generate an initial (e.g. first) channel list within the AP. This list informs the AP of which STAs are connected (associated and authenticated) with the AP 110 while using the first channel. The AP 110 retains registration information for channel change purposes.

It is noted that IEEE 802.11h specifies that a STA, rather than AP, holds a channel list. As such IEEE 802.11h places responsibility on the STA to move from one channel to the next in an effort to find an AP that has changed channels. The current disclosure avoids this STA channel searching requirement by placing responsibility with the AP to track registered STAs after a channel switch event.

Returning to FIG. 3A, after connection to the WLAN, STAs 1, 2, and 3 exchange information across the WLAN 120 as part of normal operations. This is shown in event 340. At event 345, channel congestion occurs which could be characterized by packet loss. When the packet loss becomes severe enough to cross a threshold determined by the AP, then the AP can initiate a channel switch operation.

FIG. 3B is a continuation of the FIG. 3A example transaction or event diagram 300 showing the example flow of operations of the AP 110 and STA 130. 140, and 150 of example configuration FIG. 1 while operating using the features of the current disclosure. Picking up the example flow diagram 300 of FIG. 3B at event 345, the AP 110 detects channel congestion and decides to switch to a new (e.g., second) WLAN channel. At event 350, the AP 110 preferably selects a next channel that will support all of the STAs (STA 1, STA 2, STA 3) that are already registered with the AP 110. The AP 110 transmits the newly selected (second) channel to the three STAs. This transmittal may include a channel switch announcement information element message or another equivalent message to request that each of the STAs join the WLAN 120 on a specific channel. The STAs are then free to exercise the WPA protocol handshake 200 with the AP after the AP changes channels.

At event 352, STA 1 (130) re-connects to the WLAN after the AP changes channels. As a result of the re-connection to the WLAN by the STA 1, the AP 110 re-registers STA 1 (130) with the AP on the new (second) channel at event 354. At event 356, STA 2 (140) reports a connection error. A disconnection event may be any of the forms of disconnection of FIG. 2D. In this instance the AP may detect the absence of STA 2 (140). As a result, the AP 110 records the loss of STA 2 on the new (second) channel at event 358. This report can be an update to the first list, or an entry into a second list for STA connections to a second list (such as a new channel reconnection list), to report a connection report or an unregister event.

Well noted is that STA 3 (150) is silent. STA 3 also received the switch to channel 2 message from the AP at event 350 but was unable to respond at all because of some incompatibility with STA 3 and the new channel which the AP is now using. As a result of the AP recording an unregister or disconnection notification event 358 from STA 2, and/or the fact that STA 3 has failed completely to provide connection status to the AP 110, the AP 110 selects another WLAN channel (e.g. Channel 3) at event 360. Also at event 360, the AP 110 transmits channel switch information to STA 1, STA 2, and STA 3. The intent is to switch to a channel that affirmatively supports the operation of all three STAs initially registered with the AP for operation on the WLAN.

After the channel change of AP at event 360, the STAs are free to exercise the WPA protocol handshake 200 with the AP. At event 365, STA 1 reconnects to the WLAN on the latest (third) channel selected by the AP 110. As a result of the reception of association and authentication messages from STA 1 confirming operation on the new (third) channel, the AP records the re-connection of STA 1 at event 370. This re-connection recording can be a registration of STA 1 on the new (third channel) or a re-registration of the association of STA 1 with the AP 110 or both.

At event 375, STA 2 reconnects to the WLAN on the latest (third) channel selected by the AP 110. As a result of the reception of association and authentication messages from STA 2 confirming operation on the new (third) channel, the AP records the re-connection of STA 2 at event 380. This re-connection recording can be a registration of STA 2 on the new (third channel) or a re-registration of the association of STA 2 with the AP 110 or both.

At event 385, STA 3 reconnects to the WLAN on the latest (third) channel selected by the AP 110. As a result of the reception of association and authentication messages from STA 3 confirming operation on the new (third) channel, the AP records the re-connection of STA 3 at event 390. This re-connection recording can be a registration of STA 3 on the new (third channel) or a re-registration of the association of STA 3 with the AP 110 or both.

At this point the AP 110 recognizes that all of the STAs that were originally operating on the WLAN (step 340) in association with the AP 110 are connected to a new channel. Normal STA operations with all of the registered STAs with the AP operating on the WLAN can then recommence at shown in event 395.

Thus, the channel switch was accomplished by the AP and all of the registered STAs. During the channel switch, the registered STAs were not required to process any list of possible channels as in some prior art schemes. Instead, the above-described operation of FIGS. 3A-3B assigned responsibility to the AP to keep track of registered STAs through channel changes until a channel change was made that accommodated all of the registered STAs. If a channel change had been initiated that did not allow all of the registered STAs to reconnect with the AP on a different channel, then the AP could report the STA loss.

In another option, The AP can iterate though channels until all STAs reconnect. If one or more STAs never reconnected, then the AP would eventually return to its original channel and report an error condition. In reporting an error, the AP could flash an error LED to a user. The AP could also report the error condition to its network operator using a remote management protocol like TR-069 or SNMP on a status indicator.

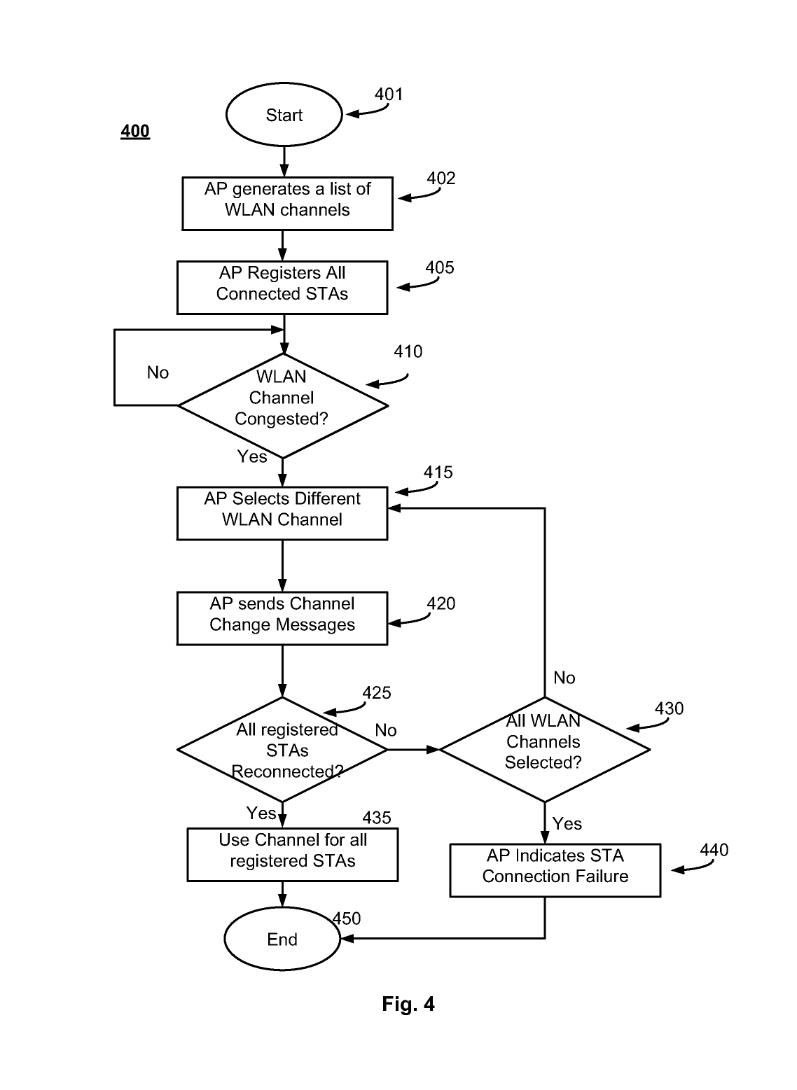

FIG. 4 is an example flow diagram 400 of a method performed by an AP using features of the current disclosure. The method 400 starts at item 401 by applying the method to a WLAN configuration such as that shown in FIG. 1. At item 402, the AP generates a list of possible WLAN channels that STAs might use while operating in the WLAN. This list may be compiled using any information available such as that available from system information or operational frequency information obtained from STA operational constraints. Thus, the AP generates a channel list for remote station operation in the wireless local area network. The channel list is used by the access point.

At item 405, the AP registers all STAs that it currently has operating on a particular channel frequency. For example, if three STAs operate on a first channel (e.g. Ch 1), then those specific STAs are recorded as operating on the frequency specified by Ch 1 with the AP. At decision point 410, the AP determines if the WLAN channel being used (e.g. Ch 1) is congested. The AP can make this determination by both measuring RF interference, packet loss, STA responsiveness, or the like and then comparing the measurement of quality to a threshold. If the threshold is exceeded, then channel congestion may be present and the method progresses to item 415. At 415, the AP selects a different WLAN channel for operation. For example, Channel 2 (Ch 2) may be selected for future operation instead of continued operation on congested Channel 1 (Ch 1). If the threshold is not exceeded then the AP can continue to monitor the current operating channel until the conditions for channel congestion appear, if ever.

At 420, the AP sends or transmits one or more channel switch messages to all remote stations to change from the first channel frequency to the second channel frequency. The message format can be that shown in FIG. 2B as an IEEE 802.11h format message. At 425, the AP determines whether or not all registered remote stations have reconnected to the access point using the second channel frequency. That is, not all registered remote stations have reconnected to the AP using the second channel. The AP can perform this step by comparing the registered remote stations (STAs) against the remote stations that have reconnected to the AP on the new channel. If all registered remote stations have not reconnected to the AP on the second channel, then at 430, the AP makes a determination if all channels in the channel list were selected. This determination is made by reviewing the channel list held by the access point and determining if all channel frequencies were tried in an attempt to operate the access point and STAs on a different channel than the first channel which became congested. If all of the channels in the channel list were selected then, the process 400 moves to item 440 where the AP indicates a remote station failure. However, if at 430, all of the channels in the channel list were not selected, then the process moves to item 415. There, a third channel frequency is selected by the AP if all channels in the channel list were not selected. Selecting a third channel frequency includes selecting a next channel on the channel list held by the access point.

The AP can then repeat item 420 and send or transmit one or more channel change messages to all remote stations to change to a third channel frequency. The AP then determines at 425 whether all registered remote stations have connected with the access point using the third channel frequency. If all of the registered stations have connected to the AP using the third channel frequency, then the third channel frequency may be used by the STAs to access WLAN resources via the AP. Otherwise, if one or more of the remote stations (STAs) cannot connect to the access point on any channel selected by the AP, then the AP produces an indication of a remote station connection failure at item 440.

From item 440 or item 435, the process 400 can move to item 450 which could be an end to a pass through the process 400. However, in another embodiment, the process 400 could loop back at item 450 to the decision block 410 where the newly operational channel is further monitored for any channel congestion. This would allow a re-entry into the process 400 for continuous support of the registered STAs using the WLAN.

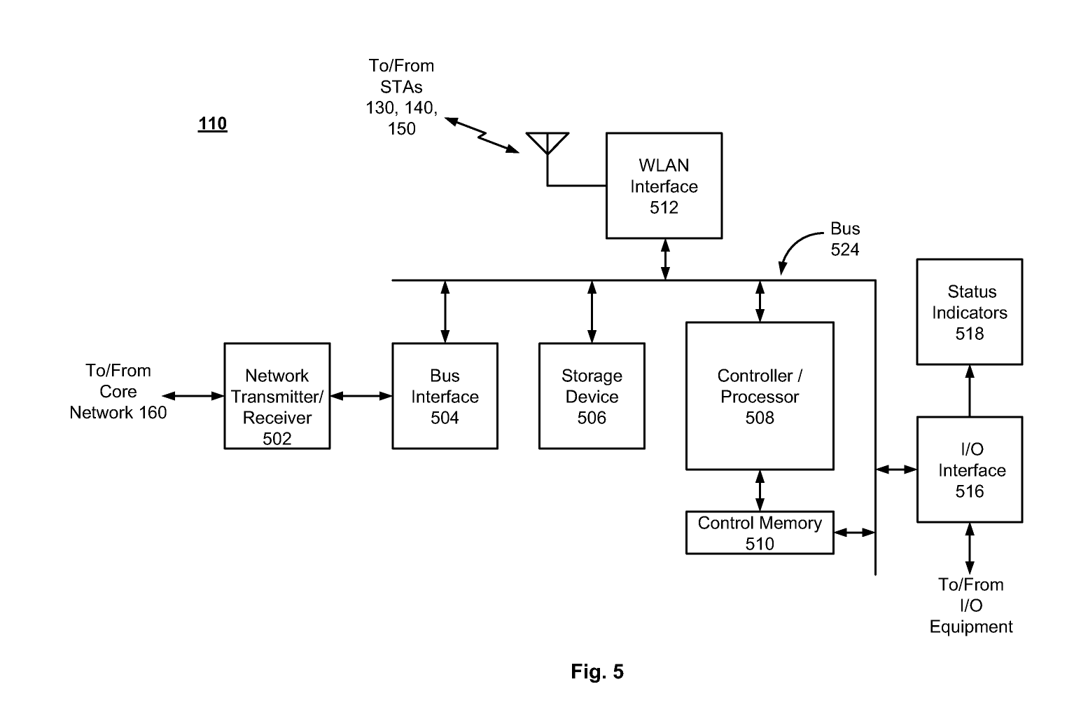

FIG. 5 is an example embodiment of an AP, such as that shown in FIG. 1, item 110. Here, a connection to a core network 160 is via the network transmitter/receiver interface 502. The core network 160 connection referred to here may include a connection to the internet or other resources which may include servers, remote or cloud memory, or other possible network services. The core network interface 502 connects to the bus interface 504 which allows access to the internal bus 524. Other, non-bus, implementations are also possible as is well known to those of skill in the art. Present on bus 524 are a storage device 506 which can be used for any general storage such as retrieved or requested data and network management data, parameters, and programs. Such network management and other programs are under the control of controller/processor 508.

This controller/processor 508 may be a single processor or a multiplicity of processors performing the tasks of network management, user interface control, and resource managements. Control memory 510 can supply program instruction and configuration control for controller/processor 508. The status indicators 518 allows a user, network owner, or network manager to see a status of the AP 110. Such status indicators may include a display, LEDs, printer interface, or data logging interface. Input/output (I/O) interface ports 516 allows the AP 110 to connect to I/O equipment such as a personal computer (not shown) or other device that can be used to configure and control the AP. The I/O interface ports 516 may include a hardline interface, such as an Ethernet interface or may operationally be substituted with an RF interface so that the AP 110 can communicate with a PC via a protocol driven interface, such as IEEE 802.11 and the like. Alternately, a remote terminal may also be connected to a WLAN operated by the AP. Other interfaces that are possible via I/O interface ports 516 are an interactive interface which may include the use of a display device, keyboard, mouse, light pen, and the like.

AP 110 has a wireless network interface 512 which allows access to and from regular remote station (STA) users to the resources of the core network 160 via the WLAN. Such an interface includes all elements to control a wireless network, including the use of wireless network protocols such as IEEE 802.11 and the like. The WLAN interface 512 has the capability to transmit and receive on different channel frequencies to accommodate the channel switch decisions made by the processor 508.

The controller/processor 508 of the AP 110 of FIG. 5 is configured to provide processing services for the steps of the methods of FIG. 4. For example, the controller processor can provide instruction control to monitor and control the interfaces of the network transmitter/receiver 502, the I/O interfaces 516 and 518, and the WLAN interface 512. Controller/processor 508 directs the flow of information through AP 110 such that the AP activities of event flow diagram FIG. 3 are performed as well as the method of FIG. 4. It is the processor or controller 508 which drives the interface of FIG. 5 to interact with the registered STAs. Status indicators 518, provide a user of the AP with a visual or audio indicators that indicate a connection failure of a remote station. Such an indicator can be an LED, a text display of remote station connection error condition or status, or an audio alert.

In one embodiment, the access point 110, operating on a wireless local area network, includes a wireless local area network interface for communicating to a plurality of remote stations (512). The processor (508) has access to memory holding instructions for controlling switching of an operational frequency of the wireless local area network. The instructions, when executed by the processor enable the processor to generate a channel list, determine if a first channel frequency is congested, and transmit one or more channel switching messages to the plurality of remote stations. The messages instruct the plurality of remote stations to switch to a second channel frequency. The processor determines that all of the plurality of remote stations have not switched to the second channel frequency. The processor then transmits one or more channel switching messages to the plurality of remote stations to switch to a third channel frequency. The processor determines if all of the plurality of remote stations have switched to the third channel. The processor operates the remote stations on the third channel frequency if all of the plurality of remote stations have switched to the third channel frequency. The status indicator 518 indicates if all of the remote stations have not switched to the third channel frequency.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms. For example, implementation can be accomplished via a hardware apparatus, hardware and software apparatus. An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device.

Additionally, the methods may be implemented by instructions being performed by a processor, and such instructions may be stored on a processor or computer-readable media such as, for example, an integrated circuit, a software carrier or other storage device such as, for example, a hard disk, a compact diskette (“CD” or “DVD”), a random access memory (“RAM”), a read-only memory (“ROM”) or any other magnetic, optical, or solid state media. The instructions may form an application program tangibly embodied on a computer-readable medium such as any of the media listed above or known to those of skill in the art. The instructions thus stored are useful to execute elements of hardware and software to perform the steps of the method described herein.

1. A method performed by an access point in a wireless network, the method comprising:
registering remote stations using the access point operating on a first channel frequency;
selecting a second channel frequency to transfer the registered remote stations from the first channel frequency;
sending one or more channel change messages to the registered remote stations to change to the second channel frequency;
determining that all registered remote stations have not connected to the access point using the second channel frequency;
selecting a third channel frequency;
sending one or more channel change messages to the registered remote stations to change to the third channel frequency;
determining if all registered remote stations have connected with the access point using the third channel frequency;
using the third channel frequency for the registered remote stations when all the registered remote stations have connected with the access point using the third channel frequency; and
producing an indication of a remote station connection failure if one or more of the remote stations cannot connect to the access point.

2. The method of claim 1, further comprising generating operational channel frequency information for remote station operation in the wireless local area network by using operational frequency information obtained from remote station operational constraints.

3. The method of claim 1, wherein registering remote stations using the access point on a first channel frequency comprises recording identification information of remote stations using a first channel frequency.

4. The method of claim 1, wherein deciding to switch channel frequency comprises detecting packet loss and determining that the packet loss exceeds a threshold.

5. (canceled)

6. The method of claim 1, wherein sending one or more channel change messages to remote stations to change to the second channel frequency comprises transmitting the channel switch message to each remote station.

7. The method of claim 1, wherein determining that all registered remote stations have not connected to the access point using the second channel frequency comprises the access point comparing the registered remote stations with the remote stations that have reconnected to the access point on the second channel.

8. The method of claim 1, further comprising determining if all channel frequencies available to the registered remote stations were selected before selecting the third channel frequency.

9. The method of claim 1 wherein selecting a third channel frequency comprises selecting a third channel frequency if all channel frequencies available to the registered remote stations were not selected.

10. An access point apparatus operating on a wireless local area network, the access point apparatus comprising:
a wireless local area network interface for communicating with a plurality of remote stations;
a processor configured to control switching of an operational frequency of the wireless local area network, the processor registering the plurality of remote stations for use on a first channel frequency, selecting a second channel frequency from channel frequencies available to all of the plurality of registered remote stations; transmitting one or more channel switching messages to the plurality of registered remote stations, the messages instructing the plurality of remote stations to switch to the second channel frequency, the processor determining that all of the plurality of remote stations have not switched to the second channel frequency, selecting a third channel frequency from the channel frequencies available to all of the plurality of remote stations, transmitting messages instructing the plurality of remote stations to switch to the third channel frequency, determining if all of the plurality of remote stations have switched to the third channel frequency, and operating the remote stations on the third channel frequency if all of the plurality of remote stations have switched to the third channel frequency; and
a status indicator for indicating if all of the remote stations have not switched to the third channel frequency.

11. The access point of claim 10, wherein the status indicator is one or more of a LED, a display, or an audio alert.

12. The access point of claim 10, further comprising a network transmitter and receiver for connecting the access point to a core network.

13. (canceled)

14. The access point of claim 10, wherein the processor decides to switch channel frequency by determining if the first channel is congested by comparing packet loss to a threshold.

15. The access point of claim 10, wherein the processor registers remote stations using the first channel frequency and determines if the registered remote stations have switched to the second channel frequency or the third channel frequency.
